(19) United States
(12) Patent Application Publication
(10) Pub. No.: US 2009/0251061 A1
(43) Pub. Date: Oct. 8, 2009

(54) Apparatus for Operating at Least One Discharge Lamp

(75) Inventor: Bernhard Siessegger, München (DE)

Correspondence Address: Viering, Jentschura & Partner - OSR, 3770 Highland Ave., Suite 203, Manhattan Beach, CA, 90266, US

(73) Assignee: Osram Gesellschaft Mit Beschraenkter Haftung

(21) Appl. No.: 12/084,464

(22) PCT Filed: Oct. 26, 2006
(86) PCT No.: PCT/EP2006/067783

§ 371 Date: May 2, 2008

(30) Foreign Application Priority Data
Nov. 2, 2005 (DE) 102005052554.7

(51) Int. Cl. H05B 41/282

(52) U.S. Cl. 315/276; 315/287

(57) ABSTRACT

The invention relates to an apparatus for operating at least one discharge lamp by means of one or more voltage converters, wherein the apparatus comprises a voltage converter which is in the form of an inverse Watkins-Johnson converter.

The invention relates to an apparatus in accordance with the preamble of claim 1.

### I. PRIOR ART

Two-stage converters for low-frequency square-wave operation of a high-pressure discharge lamp are known. FIG. 1 shows the design of a two-stage converter in accordance with the prior art. The term “converter” in this context is always intended to mean the combination of DC voltage converter and inverter, although the DC voltage converter in the sense of power electronics already represents a complete “converter”. The DC voltage converter produces approximately an output current which corresponds to the absolute value of the lamp current (U-I converter). This output current is converted by the downstream inverter into a low-frequency, virtually square-wave lamp current, which typically takes place by means of a full-bridge.

The flyback converter has found widespread use as a DC voltage converter for low input voltages U_{E} (for example at an input voltage of 12 V as in motor vehicles). FIG. 2 shows the most frequently found design of the entire electronic ballast, comprising the flyback converter, full-bridge and pulse ignition unit.

### II. DESCRIPTION OF THE FIGURES

FIG. 1 shows a two-stage design of a converter in accordance with the prior art,

FIG. 2 shows a basic design of an electronic ballast comprising a two-stage converter with a flyback converter and a full-bridge and a pulse ignition unit in accordance with the prior art,

FIG. 3 shows a basic design of an electronic ballast according to the invention with an inverse Watkins-Johnson converter and an ignition unit as well as a discharge lamp,

FIG. 4 shows the voltage ratio ε as a function of the duty factor D for three different turns ratios ü (ü=0.2 and ü=1 as well as ü=5),

FIG. 5 shows a circuit diagram of the electronic ballast in accordance with the preferred exemplary embodiment of the invention, comprising an inverse Watkins-Johnson converter with forward-blocking switches and a pulse ignition unit as well as a discharge lamp,

FIG. 6 shows a combination of an inverse Watkins-Johnson converter and step-down inductor-type converter in accordance with a further exemplary embodiment of the invention,

FIG. 7 shows standardized current and voltage profiles of the inverse Watkins-Johnson converter given a positive lamp current, and

FIG. 8 shows standardized current and voltage profiles of the inverse Watkins-Johnson converter given a negative lamp current.

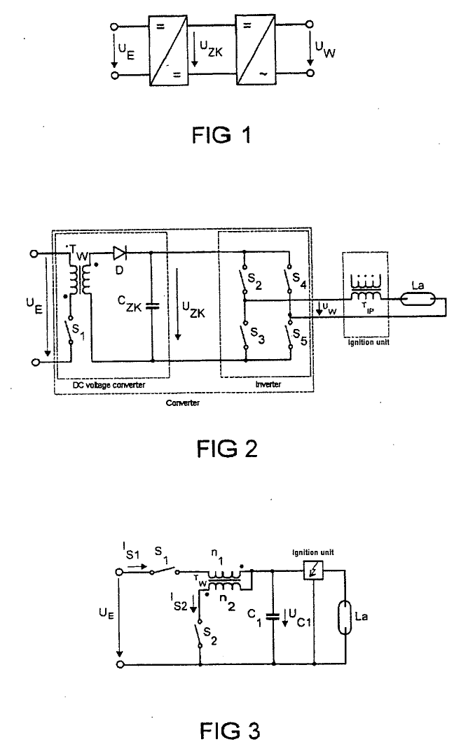

### III. DESCRIPTION OF THE INVENTION

The object of the invention is to provide a converter and an operating apparatus for a discharge lamp with a simplified design.

This object is achieved according to the invention by the features of claim 1. Particularly advantageous embodiments of the invention are described in the dependent claims.

The above design of the converter described in accordance with the prior art can be substantially simplified if a step-up DC voltage converter with selectable polarity is used. The inverter in accordance with the prior art can be dispensed with if low-frequency switching-over of the polarity of the output voltage of the DC voltage converter is used. If one considers DC voltage converters with an inductive storage element, as disclosed, for example, on page 145 of the book by Erickson, Robert W. and Maksimović, Dragan “Fundamentals of power electronics” 2nd edition, Kluwer Academic Publishers, Boulder, Colo., USA, 2002, the current-fed full-bridge and the inverse Watkins-Johnson converter meet these requirements. In both cases, in addition to the level of the output voltage, its polarity can also be changed by the duty factor. The inverse Watkins-Johnson converter is in this case preferred to the current-fed full-bridge since it manages with fewer semiconductor switches. In comparison with the above design, illustrated in FIG. 2, of the electronic ballast in accordance with the prior art, the same function can now be ensured with the operating apparatus according to the invention or the converter according to the invention with only two semiconductor switches instead of five. The operating apparatus according to the invention therefore comprises an inverse Watkins-Johnson converter in order to allow for low-frequency square-wave operation by means of a single-stage converter.

A ballast comprising an inverse Watkins-Johnson converter including an ignition unit is shown in FIG. 3. The switches used are reverse-blocking and are driven in complementary fashion with respect to one another. Ideally, precisely one of the windings n₁ or n₂ is always conducting current. In general, neither the state in which the two switches are conducting nor the state in which the two switches are off should occur, which makes implementation more difficult and usually makes corresponding snubber circuits necessary.

If, by way of simplification, a very large output capacitor C₁ is used as the basis, its voltage in the steady state, under the assumption of ideal switches and a no-losses, fixedly coupled transformer with a turns ratio ü of

$$\ddot{u} = \frac{{n}_{1}}{{n}_{2}} ,$$

is given by

$${U}_{C 1} = \frac{D}{D - \ddot{u} ( 1 - D )} {U}_{E} .$$

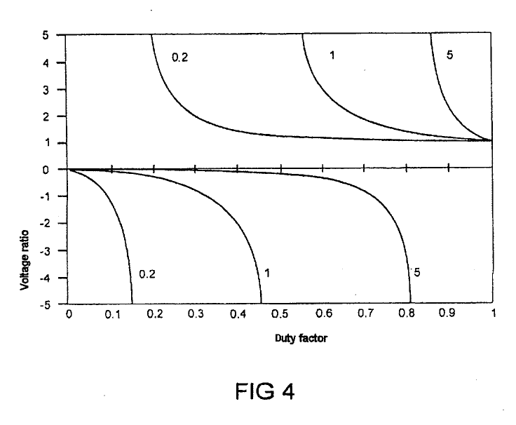

FIG. 4 illustrates this relationship, whereby the voltage ratio ε

$$ɛ = \frac{{U}_{C 1}}{{U}_{E}}$$

was used for illustrative purposes.

Owing to the pole in ε(D) and the demand for alternately providing a positive and negative output voltage, a linear controller for controlling the lamp current or the lamp power is not possible for pulse width modulation. A controller structure comprising two independent “controllers”, in each case followed by a limiter, which establishes the maximum or minimum duty factor and therefore prevents operation very close to the pole, would be conceivable. Depending on the desired polarity of the output voltage, one of the two output signals of the limiters is used for driving the switches S₁ and S₂.

If the duty factor D is selected in such a way that a positive voltage U_{C1} results, while the switch S₂ is closed the main inductance of the transformer T_{W} is magnetized by a positive current I_{S2} provided by the output capacitor C₁. Then, when the switch S₁ is closed, it is demagnetized again by the current I_{S1}, which is likewise flowing in the positive counting direction, with the energy being transmitted from the input to the output of the converter. If the converter produces a negative output voltage, when the switch S₁ is conducting, magnetization of the main inductance takes place by means of a positive switch current since the voltage applied via the winding n₁ results as the sum of the absolute values of U_{E} and U_{C1}. In contrast to the case with a positive output voltage, only a fraction of the energy stored in the transformer T_{W} now originates from the output capacitor C₁. The stored energy is then transmitted to the output when the switch S₂ is closed and when I_{S2}>0.

Given the above preconditions, when the switch S₁ is closed the voltage loading U_{S2} of the switch S₂ is given by

$${U}_{S 2} = ( 1 + \frac{1}{\ddot{u}} ) {U}_{C 1} - \frac{1}{\ddot{u}} {U}_{E}$$

and, after a switching operation, the voltage loading U_{S1}, of the switch S₁ is given by

U_{S1}=U_{E}−(1+ü)U_{C1}.

The highest voltage loading occurs if an interruption in the supply voltage occurs shortly before the lamp is ignited, i.e. the converter off-load voltage U_{W,0} is present at the converter output (in order to give: U_{C1}=U_{W,0} or U_{C1}=−U_{W,0}).

If the turns ratio were selected as one, which represents the best case with respect to switch voltage loadings, a blocking voltage at the level of twice the converter off-load voltage occurs when the input voltage is disregarded. This scenario requires comparatively high blocking voltages, which represents a drawback of the attractiveness of this concept. If it is assumed that such an operating state will occur comparatively rarely, switches with a low blocking voltage and corresponding protective circuits can be used. For example, zener diodes, Transil diodes or suppressor diodes could be used in parallel with the switches S₁, S₂, which possibly result in discharging of the output capacitor.

Furthermore, a turns ratio of ü=1 has the advantage that such a transformer T_{W} allows for the best magnetic coupling between n₁ and n₂, and therefore particularly few losses occur as a result of primary-side and secondary-side stray inductances.

Particularly low primary-side and secondary-side stray inductances can be achieved by a double-wound winding design of the transformer T_{W}. For this purpose, 5 identical windings are applied to the core, for example, using corresponding winding technology. Then, for example 2 of the 5 windings are interconnected so as to form the total winding n₁ and the remaining 3 are interconnected so as to form the total winding n₂, as a result of which winding transformation ratios of 2/3 (exclusively series circuits comprising the individual windings) or of two (n₁ comprises a series circuit of individual windings, whereas n₂ comprises a parallel circuit of the individual windings) or of 1/3 (n₁ comprises a parallel circuit of the individual windings, whereas n₂ comprises a series circuit of individual windings) can be realized.

If the ignition unit is not taken into consideration and the lamp is modeled by means of a nonreactive resistor R_{La}, the current i_{S1} through the switch S₁, changes during the period DT of the switch S₁ between

$${i}_{S 1} ( 0 ) = \frac{{U}_{C 1}^{2}}{{U}_{E} {R}_{La} D} + \frac{{U}_{C 1} - {U}_{E}}{2 {L}_{n 1}} DT$$

$$and$$

$${i}_{S 1} ( DT ) = \frac{{U}_{C 1}^{2}}{{U}_{E} {R}_{La} D} - \frac{{U}_{C 1} - {U}_{E}}{2 {L}_{n 1}} DT$$

linearly over time. In this case, T denotes the duration of a complete switching cycle. The current i_{S2} through the switch S₂ moves in similar fashion from

i_{S2}(DT)=üi_{S1}(DT)

to

i_{S2}(T)=üi_{S1}(0)

If it is assumed that both switches only conduct current uni-directionally, the demand for precisely complementary driving of the two switches S₁, S₂ by means of in each case one diode D₁ and D₂, respectively, in series with the switch S₁ and S₂, respectively, as illustrated in FIG. 5, can be provided. Thus, the semiconductor switches which are conventional in this application area, in particular transistors such as MOSFETs, IGBTs and bipolar transistors, can be used as the switches S₁, S₂.

The use of the diodes D₁, D₂ simplifies the driving considerably: if a positive output voltage is intended to be provided, S₁ should be permanently switched on and the associated drive signal should have a constant value and S₂ is supplied a drive signal which changes over time, for example is pulse-width-modulated. The reverse is true in the case of a negative output voltage. In this case, S₂ can remain permanently closed, and S₁ is supplied a drive signal which changes correspondingly over time, with the result that only S₁ implements switching operations. In order to produce an output current with alternating polarity, as is the case, for example, for operating discharge lamps designed for AC voltage, the system is periodically switched over between these two drive modes.

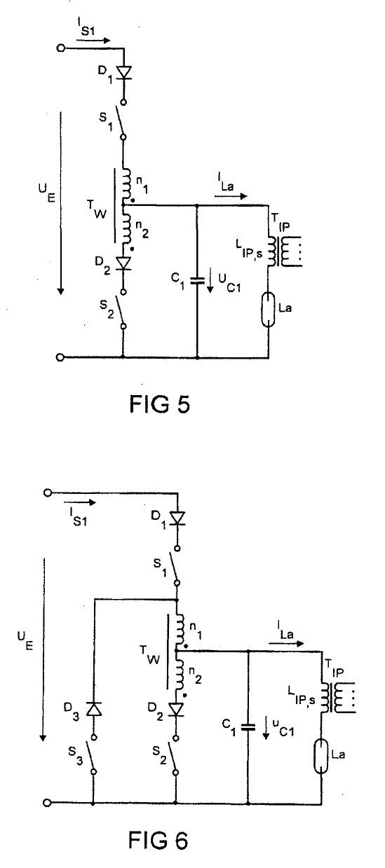

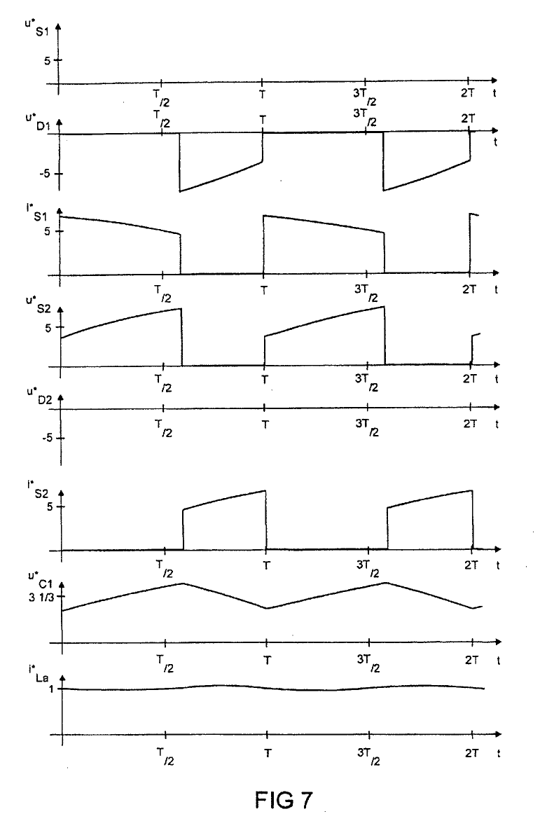

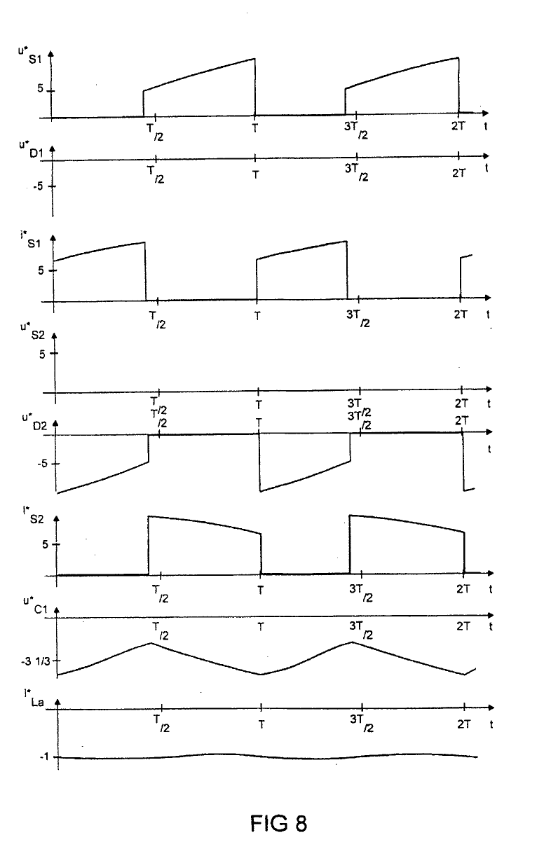

Since the converter is not capable of providing a positive output voltage which is less than the input voltage (cf. FIG. 4), the greatest permissible input voltage must be above the minimum lamp voltage, with the result that the use is restricted to low input voltages, for example the 12 V electrical system of a motor vehicle. For use at higher input voltages, it would also have to be possible to step down given a positive output voltage, as is possible, for example, with the extended circuit shown in FIG. 6. The additional diode D₃ forms, together with S₁ and the inductance Lₙ₁ of the winding n₁, a step-down inductor-type converter. In order to be able to continue to ensure the operation of the inverse Watkins-Johnson converter despite the diode D₃, said diode D₃ should only be active given a positive output voltage. This necessitates the additional switch S₃, for example a MOSFET in the reverse mode (i.e. source terminal of the MOSFET is connected to the anode of D₃). FIGS. 7 and 8 show standardized current and voltage profiles (u*ₓ=uₓ/U_{E} and i*ₓ=iₓ/I_{La}) of the corresponding instantaneous values of voltages and currents for the circuit shown in FIG. 5, with the lamp having a rated operating voltage of 40 V and a rated power of 32 W. The lamp La is operated at a low-frequency, virtually square-wave current of 130 hertz at the rated power. The ratios for a positive lamp current are shown in FIG. 7, and those for a negative lamp current are shown in FIG. 8. In this case, the ratios are shown after the end of a so-called power runup of the lamp which follows on from ignition of the lamp and in which the mean value over time of the lamp current is above the rated current of the lamp.

T_{IP} in FIGS. 5 and 6 denotes the ignition transformer of a ignition unit, whose secondary winding L_{IP,s} is connected in series with the discharge path of the lamp La.

The duty factor D transmitted to the switches S₁, S₂ of the inverse Watkins-Johnson converter is limited to values with a sufficient distance from the pole of the voltage transformation ratio ε(D) in order to avoid a steady-state operation in the region of the pole of the voltage transformation ratio ε(D).

In accordance with the preferred exemplary embodiment of the invention, the abovementioned lamp La is a mercury-free metal-halide high-pressure discharge lamp for use in a motor vehicle headlamp. In accordance with this exemplary embodiment, the abovementioned variables have the following values:

input voltage U_{E}=12 V
the transformer T_{W} has a double-wound winding design with a turns ratio of ü=1
output capacitor capacitance C₁=1 μF
inductance Lₙₗ of the winding n₁: Lₙ₁=100 μH
inductance L_{IP,s} of the secondary winding of the ignition transformer T_{IP} is 500 μH,
switching frequency f of the switches S₁, S₂: f=100 kHz.

1. An apparatus for operating at least one discharge lamp by means of one or more voltage converters, characterized in that the apparatus comprises a voltage converter, which is in the form of an inverse Watkins-Johnson converter.

2. The apparatus as claimed in claim 1, the inverse Watkins-Johnson converter comprising two alternately switching means.

3. The apparatus as claimed in claim 2, the inverse Watkins-Johnson converter having a transformer (T_{W}) with a first winding (n₁), which is connected in series with the first switching means (S₁) when the first switching means is closed, and with a second winding (n₂), which is connected in series with the second switching means (S₂) when the second switching means is closed.

4. The apparatus as claimed in claim 3, the first or the second switching means being in the form of a series circuit comprising a diode (D₁, D₂) and a semiconductor switch (S₁, S₂).

5. The apparatus as claimed in claim 4, the semiconductor switch(es) (S₁, S₂) being in the form of transistors.

6. The apparatus as claimed in claim 3, the first or the second switching means being protected against voltage
overload by zener diodes, Transil diodes or suppressor diodes arranged in parallel.

7. The apparatus as claimed in claim 4, the apparatus being designed in such a way that, in time ranges with a polarity of the lamp current which is constant over time, a drive signal with a changing state is supplied to only one of the two semiconductor switches (S₁, S₂), and a drive signal which is constant over time is supplied to the other of the two semiconductor switches (S₁, S₂), so that this other semiconductor switch is permanently switched on.

8. The apparatus as claimed in claim 2, the circuit being extended by a further switching means (S₃), so that stepping-down is possible given a positive output voltage.

9. The apparatus as claimed in claim 7, the further switching means being in the form of a series circuit comprising a diode (D₃) and a semiconductor switch (S₃).

10. The apparatus as claimed in claim 8, the further semiconductor switch (S₃) being formed by a MOSFET in the reverse mode.

11. The apparatus as claimed in claim 3, the turns ratio (ü) of the transformer (T_{W}) being in the range of between 1/5 and 5.

12. The apparatus as claimed in claim 10, the turns ratio (ü) of the transformer (T_{W}) being one.

13. The apparatus as claimed in claim 3, the windings of the transformer (T_{W}) being double-wound.

14. The apparatus as claimed in claim 2, means for limiting the duty factor (D) which is transmitted to the semiconductor switches (S₁, S₂) being provided.

15. The apparatus as claimed in claim 3, means for limiting the duty factor (D) which is transmitted to the semiconductor switches (S₁, S₂) being provided.

16. The apparatus as claimed in claim 4, means for limiting the duty factor (D) which is transmitted to the semiconductor switches (S₁, S₂) being provided.

17. The apparatus as claimed in claim 5, means for limiting the duty factor (D) which is transmitted to the semiconductor switches (S₁, S₂) being provided.

18. The apparatus as claimed in claim 6, means for limiting the duty factor (D) which is transmitted to the semiconductor switches (S₁, S₂) being provided.

19. The apparatus as claimed in claim 7, means for limiting the duty factor (D) which is transmitted to the semiconductor switches (S₁, S₂) being provided.
